(19) United States
(12) Patent Application Publication
(10) Pub. No.: US 2022/0396398 A1
(43) Pub. Date: Dec. 15, 2022

(54) INDUSTRIAL CONTAINMENT BAGS WITH AN INTEGRATED AND NON-PERFORATED INTERIOR LINER

(71) Applicant: I.C.E. Packaging Company, LLC, Madisonville, TN (US)

(72) Inventors: Shirley A. CROFT, Madisonville, TN (US); Elisabeth WOODCOCK, Decatur, TN (US)

(73) Assignee: I.C.E. Packaging Company, LLC, Madisonville, TN (US)

(21) Appl. No.: 17/833,377

(22) Filed: Jun. 6, 2022

Related U.S. Application Data
(60) Provisional application No. 63/208,999, filed on Jun. 10, 2021.

(51) Int. Cl. B65D 30/08; B65D 33/24; B65D 33/02

(52) U.S. Cl. CPC B65D 29/02; B65D 33/24; B65D 33/02

(57) ABSTRACT

The present invention is directed to new and improved industrial containment bags, wherein the improvement comprises integrating a non-perforated liner as a part of the bag, and wherein the integration is accomplished by a direct attachment means (e.g., by a sewing process). In certain embodiments of this invention, the improved containment bags have a top opening. In other embodiments of this invention, the improved containment bags have an end or sidewall opening. The present invention is also directed to methods of manufacturing, using, filling, lifting, transporting, storing, and/or disposing of such new and improved industrial containment bags

This non-provisional application claims priority to, and the benefit of, U.S. Provisional Patent Application No. 63/208,999, filed on Jun. 10, 2021, herein incorporated by reference.

### FIELD OF THE INVENTION

The invention pertains to new and improved industrial containment bags which can be used for transporting, disposing and/or storing of: (a) hazardous materials with varying levels of radioactivity, (b) industrial bulk materials, and/or (c) industrial waste materials; as well as, methods of manufacturing, using, filling, lifting, transporting, storing, and/or disposing of such bags, wherein the improved industrial containment bag includes an integrated and non-perforated interior liner.

### BACKGROUND OF THE INVENTION

Methods of, and apparatus for, transporting, storing and/or disposing of cargo (or goods) are as varied as the cargo itself. As for transporting, that involves moving one or more items of the cargo from one place (i.e., the point of origin) to another place (i.e., the destination point). The cargo may be said to be “shipped” or “transported” from the point of origin to the destination point.

When the items of the cargo are loose, such items are not contained for transport by other than the walls or the bottom or the top of the transport vehicle (e.g., a railroad car, a dumpster, a truck, etc.) that is used for the transport. Thus, the loose items are not in packages or boxes when they are transported. Such loose cargo is said to be transported “in bulk” and may be referred to as industrial “bulk cargo” or as industrial “bulk goods”.

Transportation of industrial bulk materials and wastes in the United States is regulated by the United States Department of Transportation. For normal bulk cargo, such as plastic pellets for extruding machines or bulk foodstuffs, the regulations are relatively simple, as compared to regulations controlling the transport of industrial wastes and/or industrial hazardous materials. Such industrial wastes and/or industrial hazardous materials may include waste generated during manufacturing operations, such as toxic chemicals, or waste resulting from discarding a product after use, e.g., polychlorinatedbiphenols (“PCBs”) which were in electrical transformers. Although such toxic chemicals and PCBs are closely regulated at the state and Federal levels, industrial hazardous materials that are radioactive or that are nuclear wastes (“radioactive hazardous material waste”) are even more closely regulated. Such radioactive hazardous material waste includes materials resulting from the manufacture of weapons (e.g., radioactive dirt) and radioactively contaminated demolition debris (e.g., building materials, concrete pillars and beams and scrap steel found, for example, at sites which are being dismantled). Radioactive hazardous material waste may include radioactive materials that meet criteria as “low level radioactive” radioactive hazardous material waste, which while being radioactive, their level of radioactivity is typically two picocuries or less.

Regulations controlling the containment, transportation, disposal and/or storing of such radioactive hazardous material waste include the following:

(i) a complete accountability and documentation of every pound of radioactive hazardous material waste;

(ii) state licensing of certain containers in which radioactive hazardous material waste is transported, e.g., licensing of intermodal containers (“IMCs”), which includes documenting the transport of such IMCs;

(iii) Federal, local, and state control of the movement of radioactive hazardous material waste at or from a site at which the radioactive hazardous material waste was generated (the “remediation site”);

(iv) requirements that the containers in which radioactive hazardous material waste is transported either does not become contaminated with the radioactive hazardous material waste, or if they become contaminated, that such contaminated containers be decontaminated after use;

(v) prohibitions against transferring loose (uncontained) radioactive hazardous material waste from one transport container to another, and if radioactive hazardous material waste is to be transferred from one transport vehicle to the next transport vehicle, requiring that the radioactive hazardous material waste be contained within a licensed container prior to and during the transfer;

(vi) establishing “exclusionary zones” at sites at which radioactive hazardous material waste is located, defining Personal Protection Levels (“PPLs”) which vary according to the level of radioactivity of the radioactive hazardous material waste, and requiring that personnel who enter such “exclusionary zones” wear clothing suitable for protecting against injury from the radioactive hazardous material waste (i.e., personnel must be “suited up”) according to the applicable PPL; and

(vii) prohibitions against allowing loose liquid (“free liquid”) from being transported in anything other than a special tank car (whether via railroad or truck); for example.

If the point of origin (e.g., the remediation site) does not have a railroad spur on-site (i.e., if it is not “rail-served”), such transporting can be “intermodal”, such as via truck (one mode) from the remediation site (the point of origin) to a nearby railroad for long-distance railroad transport (another mode) to the destination point. If the destination point is not rail-served and the licensed container is an intermodal container (“IMC”), the railroad can be used to deliver the licensed IMC (which contains radioactive hazardous material waste) to an intermodal railyard near the destination point. At the intermodal railyard, such licensed IMC can be taken off the railroad car and put on a truck for further transport to the destination point (e.g., a storage site for the radioactive hazardous material waste). Such IMC may be moved within the storage site to a “cell” to which the radioactive hazardous material waste from the particular point of origin is assigned for storage.

Radioactive hazardous materials are said to be “stored” because the radioactive materials of such hazardous material waste do not decompose in the manner of other hazardous material waste, due to the very long half-life of radioactive materials. Hazardous material waste that does not contain radioactive materials is said to be “disposed of”, or put into a landfill for “disposal”, because it decomposes over a relatively short time period, e.g., a few years.

Low level radioactive contaminated hazardous solid waste materials and debris are generated during industrial maintenance, spill response, and building decontamination projects. Such debris can include piping, pumps, valves, duct work, process tanks, wooden and concrete flooring, spill control booms, personnel protective equipment (PPE), soils and a wide variety of other solid items. Disposal of such radioactive contaminated hazardous waste materials is a major concern, especially in the United States. Low level radioactive contaminated wastes are defined in the Low-level Radioactive Waste Policy Act of 1985, as later amended (including Class A, B and C wastes) 40 USC 2021, and also in 10 CFR 61.2.

Low level radioactive wastes are generally defined as radioactive waste not classified as high-level radioactive waste (those being transuranic waste, spent nuclear fuel, or byproduct material as defined in Section 11e (2) of the Atomic Energy Act (AEA)). Low level radioactive wastes characterization does not depend upon the level of radioactivity it contains. Solid wastes are defined in Resource Conservation and Recovery Act (RCRA).

Hazardous wastes are solid wastes meeting certain criteria as established in (and regulated by) the RCRA—See e.g., 40 CFR Part 261. Mixed Wastes are a specific class of hazardous wastes and include a mix of low-level radioactive wastes and hazardous wastes. Such mixed wastes are regulated by both the RCRA and the AEA. While these types of contaminated materials are generally disposed in landfills, the contaminated solid materials have to be properly treated and “packaged” for disposal to reduce the potential for spread of contamination by leachate. While the materials of concern are solid materials (as opposed to liquid), some entrained liquids may be present in the materials. In the following, the materials are understood to be such solid low-level radioactive contaminated hazardous wastes or “mixed wastes” (as classified by the Department of Energy and the Nuclear Regulatory Commission).

Generally, the contaminated materials are stored on site in temporary containers, such as metal drums or boxes. For transport and disposal, the materials are moved out of the temporary storage containers to an approved disposal container and the approved disposal container is then buried in a landfill. An approved disposal container is generally a highly corrosion resistant container, such as a stainless-steel container or a plastic drum or box. Prior to the burying of the approved disposal container, the container will be sealed shut, such as by welding the container top shut to prevent fluids from entering or exiting the container. Standard metal boxes or standard metal drums cannot be used for ultimate disposal, unless the hazardous materials in the interior of the metal box are encased in an encapsulating material within the metal container, such as Portland cement. However, encasement of the materials makes that container extremely heavy, and presents significant problems in shipping due to the weight.

Low-level radioactive hazardous waste materials may be disposed of using a macroencapsulation technique. In the industry, the term “macroencapsulation” is defined as the encapsulation of the hazardous materials with: (1) surface coating materials, or (2) the use of a jacket of inert inorganic materials to substantially reduce surface exposure to potential leaching media. The treatment objective of macroencapsulation is to meet the treatment standards for debris as specified in 40 CFR 268.45 and radioactive lead solids as specified in 40 CFR 268.40 and 40 CFR 268.42. Depending upon the size and weight of the waste and the radiation hazard presented by that waste either a commercially available macroencapsulation unit or a custom macroencapsulation process will be used.

Conventional industrial containment bags are typically not used for disposal of debris having many sharp or jagged edges, as the integrity of the bag with such sharp-edged debris could be jeopardized. For disposal of these types of materials, the standard macroencapsulation techniques are used. These include placing the wastes in a stainless-steel box or plastic drum, or encased in Portland cement in a standard metal box.

The United States guidelines specify testing requirements that certain packaging must undergo to be certified—see e.g., 49 CFR 173.465. Included in these testing/certification procedures are a free drop test and a stacking test. The free drop test requires a package to be loaded or filled to its design weight capacity and dropped from a specific height (e.g., 1-10 feet, depending on design, weight, and/or materials contained therein) and to maintain structural integrity after impact. The stack test requires a loaded package to be subject to a compressive load of, for example, 2-10 times the actual capacity weight of the package. Such testing requirements place substantial restrictions on possible construction of the packaging. For packaging that comprises a flexible bag capable of being lifted when loaded, the drop test and stack test present heavy design hurdles—see generally, 49 CFR 173 (incorporated herein in its entirety by reference) and specifically Subpart I. Certain packaging design guidelines for Industrial Packaging, Types 1, 2, or 3, or Type A package (see e.g., 40 CFR 173.403).

Transportation of industrial bulk materials, industrial wastes and/or industrial hazardous materials with varying levels of radioactivity is similarly regulated in Europe and other parts of the world. Industrial containment bags designed to large scale storage and transportation are typically adapted to carry loads in excess of 10,000 pounds.

Notwithstanding the extensive use of the industrial containment bags throughout the world, studies of such conventional methods of, and apparatus for, manufacturing, using, filling, lifting, transporting, storing and/or disposing of the same have shown that fairly significant problems exist that have yet to be remedied. Many of these problems pertain to the bags' closure systems, as well as to the inherent flexible nature of industrial containment bags.

For example, since industrial containment bags can be used to lift, transport, store and/or dispose of tens of thousands of pounds of industrial wastes—some of which are highly toxic and/or radioactive, it is critical that the bags' closure system(s) maintain secure once sealed, and that such closure system(s) remain uncompromised during typical lifting, transporting, storing and/or disposing processes. For, if a closure system of an industrial containment bag containing thousands of pounds of highly toxic or radioactive material was to fail, the results will most likely be catastrophic and extremely dangerous to the surrounding people and environment.

Moreover, since industrial containment bags inherently have at least a partially flexible nature, during their lifting and transporting processes, materials contained therein often times shift. This, in turn, can result in there being an uneven load distribution in the bag. Such unevenness can cause the bag to tip over and/or to slip off of its lifting or transportation device. If this was to occur, the integrity of the bag's closure system (and/or the bag's outer surface itself) can be compromised. As stated above, if an industrial containment bag containing thousands of pounds of highly toxic or radioactive material was to fail, this will produce catastrophic and extremely dangerous results.

Accordingly, those in the industrial containment bag industry are continually seeking new and better processes and technologies, not only for sealing such bags (especially those designed for containing toxic or radioactive wastes); but also, for ensuring that such bags remain sealed while they are being handled. Accordingly, if there were methods and/or technologies that can improve the overall integrity of such a bag during its lifting, transporting, storing and/or disposing processes (e.g., by providing methods/technologies for improving the integrity and sealing capabilities of the closure system(s) being employed in industrial containment bags and/or by providing methods/technologies for assessing the load balance of the materials being contained therein so that, if necessary, adjustments can be made before something catastrophic was to occur), such would be overwhelmingly welcomed by all in the industry as a great advancement in the art.

In some applications of industrial containment bags, it is necessary to contain bulk materials in a manner which minimizes the permeability of the bag's contents to the surrounding environment. This is often the case where the bag's contents are a liquid and/or hazardous material. In such circumstances, the industrial containment bag often includes the implementation of some sort of a liner.

If employed, liners can either be a separate container which is merely “dropped into” the industrial containment bag. Liners can also be “integrated” as one of the layers of the industrial containment bag.

In instances where a liner is integrated as a layer of a containment bag, one way in which this has been done is by having the liner directly sewn to the interior surface of the bag. While sewing the liner to the bag's interior surface may work for some applications, if it is critical to significantly minimize any permeability of the bag's contents to the surrounding environment, this process cannot be used since the sewing process results in perforating parts of the liner. These perforations will, in turn, provide points through which the bag's contents can permeate through to the surrounding environment.

Another way in which liners have been integrated as a layer of a containment bag is by having the liner adhered to the interior surface of the bag. While adhering the liner to the bag's interior surface may also work in some applications, if the containment bag has an end or sidewall opening (as opposed to a top opening), this adhering process requires that, after the containment bag is constructed, individuals will need to enter the opening of the containment bag with the liner, and attempt to adhere the liner to the bag's interior surfaces. Not only is this a difficult, and sometimes very dangerous, process, for relatively smaller containment bags, this adhering process becomes almost impossible to perform. It is also often times difficult to ensure that the tightly adhered to all of the bag's perimeter edges.

Therefore, one object of this invention is to provide new and improved industrial containment bags with an integrated and non-perforated liner, wherein the integration is accomplished by fixedly attaching the non-perforated liner to the containment bag by a direct attachment means (e.g., by a sewing process).

Another object on this invention is to provide new and improved industrial containment bags with an end or sidewall opening, wherein the improved bag has an integrated and non-perforated liner, and wherein the integration is accomplished by a direct attachment means (e.g., by a sewing process).

Other objects will become apparent to those skilled in the art as the various embodiments of the invention become better understood by reference to the following DETAILED DESCRIPTION, especially when such is considered together with the accompanying CLAIMS appended hereto, and the FIGURES, briefly described below.

### BRIEF SUMMARY OF THE INVENTION

Briefly, the present invention is directed to new and improved industrial containment bags, wherein the improvement comprises integrating a non-perforated liner as a part of the bag, and wherein the integration is accomplished by a direct attachment means (e.g., by a sewing process). In certain embodiments of this invention, the improved containment bags have a top opening. In other embodiments of this invention, the improved containment bags have an end or sidewall opening. The present invention is also directed to methods of manufacturing, using, filling, lifting, transporting, storing, and/or disposing of such new and improved industrial containment bags.

### BRIEF DESCRIPTION OF THE DRAWINGS

The present invention is illustrated by way of example, and not by way of limitation, in the figures of the accompanying drawings, in which:

FIG. 1 is a perspective view of a one embodiment of a new and improved industrial containment bag encompassed by this invention, wherein the bag comprises: (a) an exterior layer with a downwardly-opening end flap, and (b) an integrated non-perforated liner, wherein the integration of the liner is accomplished by a direct attachment means (e.g., by a sewing process).

FIG. 2 is a perspective view of a one embodiment of a non-perforated liner with an end opening which can be integrated by a direct attachment means (e.g., by a sewing process) into a new and improved industrial containment bag encompassed by this invention.

FIG. 3A is cross-sectional view of a non-perforated liner of a new and improved industrial containment bag encompassed by this invention, prior to its integration to the bag's outer layer by a direct attachment means (e.g., by a sewing process).

FIG. 3B is cross-sectional view of the outer layer of a new and improved industrial containment bag encompassed by this invention, prior to the integration of non-perforated liner by a direct attachment means (e.g., by a sewing process).

FIG. 4A is a portion of a cross-sectional view of a non-perforated liner encompassed by this invention showing the liner's integration tab.

FIG. 4B is a portion of a cross-sectional view of a new and improved industrial containment bag encompassed by this invention, showing one embodiment of how the non-perforated liner is integrated to the bag by a sewing process.

FIG. 5 is cross-sectional view of the new and improved industrial containment bag encompassed by this invention illustrated in FIG. 1.

FIG. 6 is a perspective view of a one embodiment of a how to make a non-perforated liner with an end opening which can be integrated by a direct attachment means (e.g., by a sewing process) into a new and improved industrial containment bag encompassed by this invention.

FIG. 7 is a perspective view of a one embodiment of a new and improved industrial containment bag encompassed by this invention, wherein the bag comprises: (a) an exterior layer with an upwardly-opening end flap, and (b) an integrated non-perforated liner, wherein the integration of the liner is accomplished by a direct attachment means (e.g., by a sewing process).

FIG. 8 is a perspective view of a one embodiment of a new and improved industrial containment bag encompassed by this invention, wherein the bag comprises: (a) an exterior layer with a downwardly-opening end flap, and (b) an integrated non-perforated liner, wherein the integration of the liner is accomplished by a direct attachment means (e.g., by a sewing process), and wherein the bag is in its fully-closed configuration.

### DETAILED DESCRIPTION OF THE INVENTION

Unless defined otherwise, all technical terms used herein have the same meanings as commonly understood by those of ordinary skill in the art. While specific devices and methods are being described, any devices and methods that are similar or equivalent to those described herein can be used in the practice of, and are encompassed by, the present invention. This includes such similar or equivalent devices and methods which have not yet been discovered or developed, but after being discovered or developed would have been obvious to use or implement to those skilled in the art at the time that this invention was made.

In the following description, details are set forth in order to provide a more thorough understanding of the present invention. That being said, it will be apparent to skilled artisans that the various embodiments of the invention disclosed herein may be practiced without all of the recited specific details.

The present invention is directed to new and improved industrial containment bags, wherein the improvement comprises integrating into the bag a non-perforated liner, and wherein the integration is accomplished by fixedly attaching the non-perforated liner to the containment bag by a direct attachment means (e.g., by a sewing process). The present invention is also directed to methods of manufacturing, using, filling, lifting, transporting, storing, and/or disposing of such new and improved bags.

In one embodiment of this invention, the new and improved industrial containment bags with an opening on the bag's top and with an integrated non-perforated liner, wherein the integration of the non-perforated liner is accomplished by a direct attachment means (e.g., by a sewing process).

In another embodiment of this invention, the new and improved industrial containment bags with an opening on the bag's end or sidewall and with an integrated non-perforated liner, wherein the integration of the non-perforated liner is accomplished by a direct attachment means (e.g., by a sewing process).

Yet another embodiment of the invention, is a method of making new and improved industrial containment bags with an opening on the bag's top and with an integrated non-perforated liner, wherein the integration of the non-perforated liner is accomplished by a direct attachment means (e.g., by a sewing process).

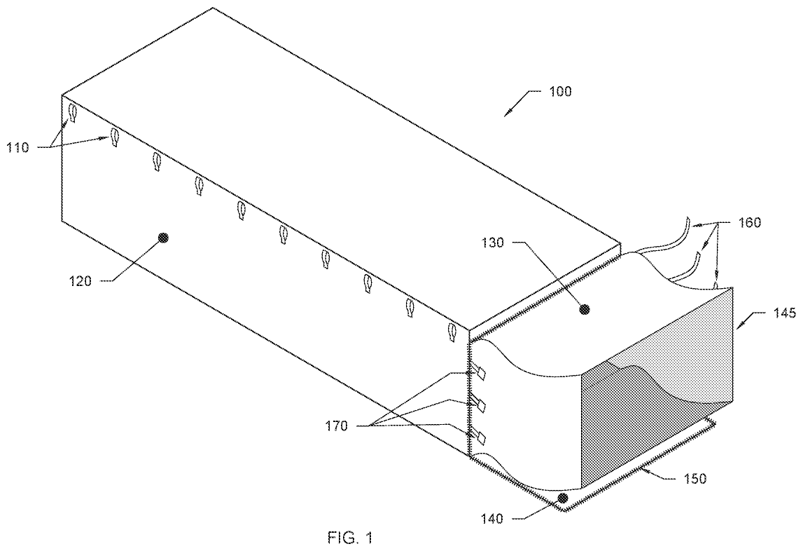

FIG. 1 is a perspective view of a one embodiment of a new and improved industrial containment bag encompassed by this invention, wherein the bag comprises: (a) an exterior layer with a downwardly-opening end flap, and (b) an integrated non-perforated liner, wherein the integration of the liner is accomplished by a direct attachment means (e.g., by a sewing process). In FIG. 1, industrial containment bag 100 can be “self-supporting” (i.e., able to stand in an upright and opened position without the use of an external supporting structure when empty) or “non-self-supporting” (i.e., requires the use of an external supporting structure to be able to stand in an upright and opened position when empty). Below, there is a more detailed description of what constitutes “self-supporting” and “non-self-supporting” industrial containment bags.

For illustrative purposes only, the containment bag shown in FIG. 1 will be deemed to be a “non-self-supporting” bag. Accordingly, containment bag 100 is made entirely of non-self-supporting materials. Since containment bag 100 is non-self-supporting, it is designed to be used in conjunction with an external supporting structure such as, for example, a “dumpster-type” container (defined infra.) or a “loading frame” (defined infra.).

It should be noted that, when used with such supporting structures, non-self-supporting bags typically employ some method for holding their sidewalls in an upright position within the structure so that the bag's opening substantially aligns with the supporting structure's opening when the bag is empty. One example of such a method used in the industry to hold up the bag's sidewalls employs the use of a series of straps having one end which is attached to the external surface of the bag's sidewalls and another end, which is lose (a.k.a. “hold-up straps”). In practice, after a non-self-supporting bag is placed into the open cavity of its supporting structure, the hold-up straps' loose ends are pulled outwardly until the bag's opening substantially aligns with the supporting structure's opening; and thereafter, secured in that position by being affixed to the outside wall of the support structure. This particular hold-up method is typically employed with non-self-supporting bags that have an opening which is position directly on, or aligned with but inwardly spaced from, the bag's top perimeter edge.

Another example of a conventional method used in the industry to hold up the walls of a non-self-supporting bag when it is empty and positioned within a supporting structure is to fold the upper portion of the bag's sidewalls over the edge of the supporting structure's walls. This method can only be used with bags having a closure system centrally-positioned on the bag's top portion when closed.

Yet another example of a conventional method used in the industry to hold up the walls of a non-self-supporting bag when it is empty and positioned within a supporting structure is through the use of hold-up loops which can be removably attached to the walls of the container or loading frame. The containment bag illustrated in FIG. 1 employs the use of a series of hold-up loops 110 positioned near or along the top perimeter edge of at least two of the bag's opposing external walls. In FIG. 1, due to the perspective view, only one series of hold-up loops 110 is illustrated.

Containment bag 100 includes an outer bag layer 120 and an integrated non-perforated liner 130. In this particular embodiment, outer bag layer 120 and non-perforated liner 130 both have closable openings. Also in this particular embodiment, the closable opening of outer bag layer 120 is on its end wall, and the closable opening of non-perforated liner 130 is also on its end wall and substantially aligns with the closable opening of outer bag layer 120.

In the particular configuration illustrated in FIG. 1, the opening of outer bag layer 120 is a downwardly-opening flap 140; and the opening of non-perforated liner 130 is a “duffel-type” opening 145. Also in this particular configuration, the closure system of flap 140 is a U-shaped a perimeter zipper 150; and the closure system of the liner's duffel opening 145 is tape.

In addition to the closure systems of containment bag 100, the embodiment illustrated in

FIG. 1 further includes a tie system to secure flap 140 in its closed position. Here, the tie system includes a series of straps 160 positioned along one sidewall of bag 100, and a corresponding series of receiving buckles 170 along the opposing sidewall of bag 100. Straps 160 should have a length long enough to extend across the flap 140 once it is secured in its closed position, and to be secured to their corresponding receiving buckles 170.

As for the location of the opening of the outer bag layer and of the non-perforated liner, it is within the scope of this invention for it to be on the bag's top, end wall or sidewall. All that matters is that the opening of the outer bag layer and of the non-perforated liner are substantially aligned with one another.

As for the configuration of the bag's opening (whether it is on the bag's top, end wall or sidewall), it is within the scope of this invention for the opening to have a perimeter opening configuration (i.e., a “flap” opening) or a central opening configuration (i.e., a “duffel-type” opening). It is also within the scope of this invention for openings of the outer bag layer and of the non-perforated liner to be the same as one another or different from one another—the latter embodiment being illustrated in FIG. 1.

As for bag's opening closure system (whether the opening is a perimeter opening configuration or a central opening configuration), it is within the scope of this invention for the closure system to be a zipper system, a hook and loop system, a tie system, a tape system, or any combination thereof. It is also within the scope of this invention for closure system of the outer bag layer and of the non-perforated liner to be the same as one another or different from one another—the latter embodiment being illustrated in FIG. 1.

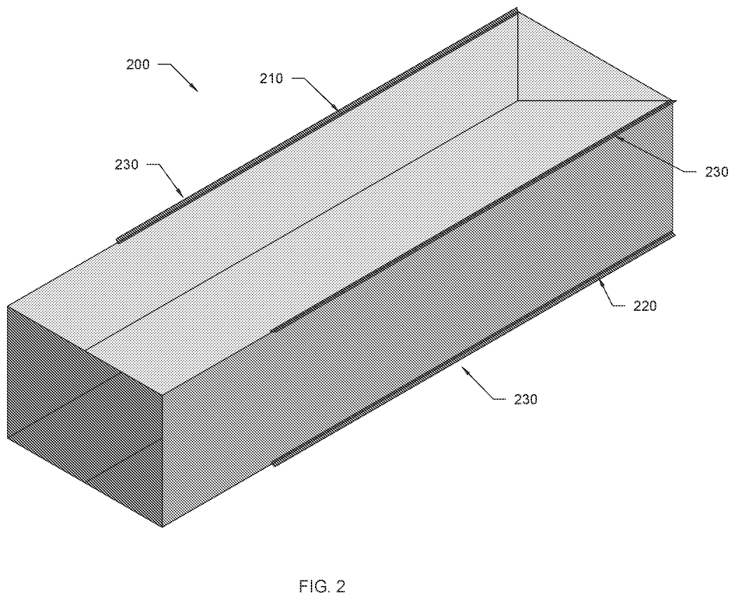

FIG. 2 is a perspective view of a one embodiment of a non-perforated liner with an end wall opening which can be integrated by a direct attachment means (e.g., by a sewing process) to form a new and improved industrial containment bag encompassed by this invention. As seen in FIG. 2, the non-perforated liner 200 has a top perimeter edge which is comprised of two opposing and parallel longitudinal upper perimeter edge sections 210 and two opposing and parallel lower perimeter edge sections 220. In this particular embodiment, running along each of these upper edge sections 210 and lower edge sections 220 are integration tabs 230. Non-perforated liner 200 also has a top perimeter edge which is comprised of two opposing and parallel lateral upper perimeter edge sections which are perpendicular to the liner's upper longitudinal upper perimeter edge sections. Similarly, non-perforated liner 200 further has a bottom perimeter edge which is comprised of two opposing and parallel lateral lower perimeter edge sections which are perpendicular to the liner's lower longitudinal lower perimeter edge sections.

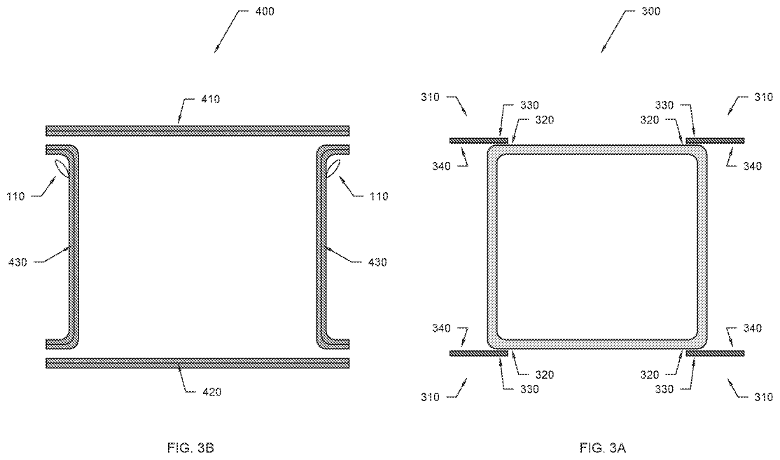

In this illustrated embodiment, a series of integration tabs is used to fixedly secure the non-perforated liner to the bag's at least one outer layer. In this particular embodiment, each of the series of integration tabs has a first end that is fixedly secured to a portion of the non-perforated liner's top perimeter edge by a “non-perforation securing means” (defined infra) and a second end that freely extends beyond the tab's secured first end. In one particularly preferred embodiment, the non-perforated liner's integration tabs comprise webbing straps, where a first end of the strap is secured to the non-perforated liner's perimeter edges via a means which does not perforate the walls of the liner (i.e., hereinafter a “non-perforation securing means”) such as, for example, by tape, glue, etc. and a second end of the strap that freely extends beyond the tab's secured first end; and thus, beyond the liner's sidewalls. For example, in this particular embodiment, the second end of each of the series of integration tabs is sandwiched between a portion of the outer layer's top and sidewall portions; and thereafter, all three layers are sewn together such that the second end of the strap is incorporated into a portion of the outer layer's top perimeter edge. The configuration of this particular embodiment of liner's integration tabs 230 is more clearly illustrated in FIGS. 3A, 4A, 4B and 5—described infra in more detail.

Specifically, FIG. 3A shows a cross-sectional view of a non-perforated liner 300 of a new and improved industrial containment bag encompassed by this invention, prior to its integration to the bag's outer layer by a direct attachment means (e.g., by a sewing process). In this figure, the there is an integration tab 310 secured to the perimeter edges 320 of liner 300. In this particular embodiment, liner 300 has an upper and lower series of integration tabs. As mentioned above, one side 330 of integration tabs is secured to the non-perforated liner's perimeter edges via a non-perforation securing means such as, for example, by tape, glue, etc., and the other side 340 of the integration tabs freely extends beyond the liner's walls.

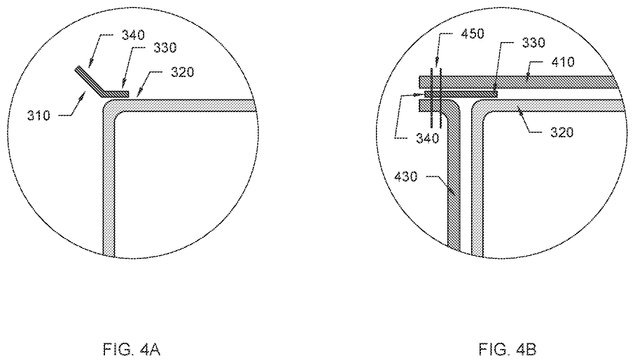

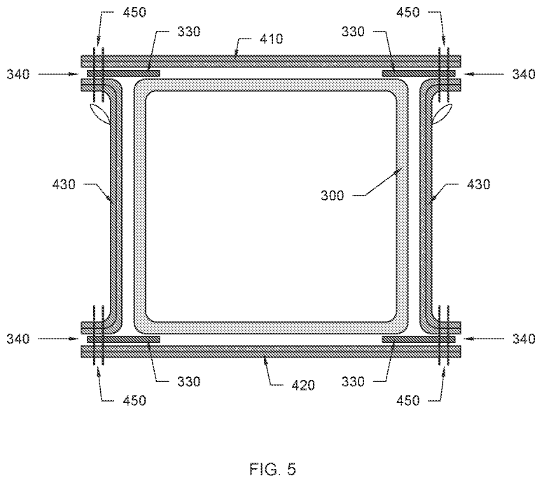

When practicing this particular embodiment of the invention, the second side (i.e., the freely-extending end) of each of the upper series of integration tabs is sandwiched between a portion of the outer layer's top portion and a portion of said outer layer's sidewall portions; and thereafter, being directly attaching to outer layer 400 by sewing it into a portion of outer layer 400′s top perimeter edge. Also, the second side (i.e., the freely-extending end) of each of the lower series of integration tabs is sandwiched between a portion of the outer layer's bottom portion and a portion of the outer layer's sidewall portions; and thereafter, being directly attaching to outer layer 400 by sewing it into a portion of outer layer 400′s bottom perimeter edge. For example, as illustrated in FIGS. 3A, 3B, 4A, 4B and 5, the freely-extending ends 340 of integration tabs 310 are designed and configured to be sandwiched between the top wall portion 410, the bottom wall portion 420 and the sidewall portions 430 of outer bag layer 400. Thereafter, the freely-extending ends 340 of integration tabs 310 that are sandwiched between the various wall portions of outer bag 400, are fixedly attached thereto by sewing as illustrated by stiches 450 in FIGS. 4B and 5. As illustrated in FIGS. 3A, 3B and 5, the size, shape and configuration of the bag's integrated non-perforated liner should be substantially the same as that of the bag's outer layer.

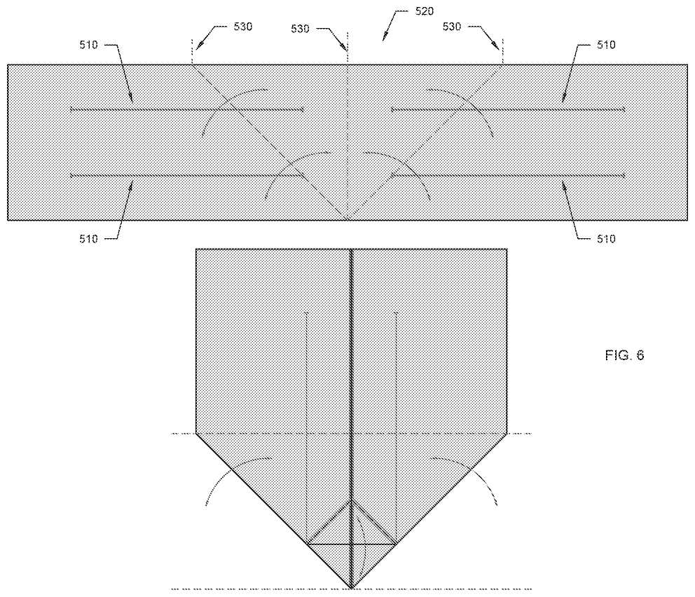

FIG. 6 is a perspective view of a one embodiment of a how to make a specific non-perforated liner by first securing four separate integration tabs 510 via a non-perforation securing means such as, for example, by tape, glue, etc. to locations on a single sheet of liner material 520 which will end up being the liner's perimeter edges, and then folding liner material 520 along the designated dotted lines 530 and securing the folds with a non-perforation securing means.

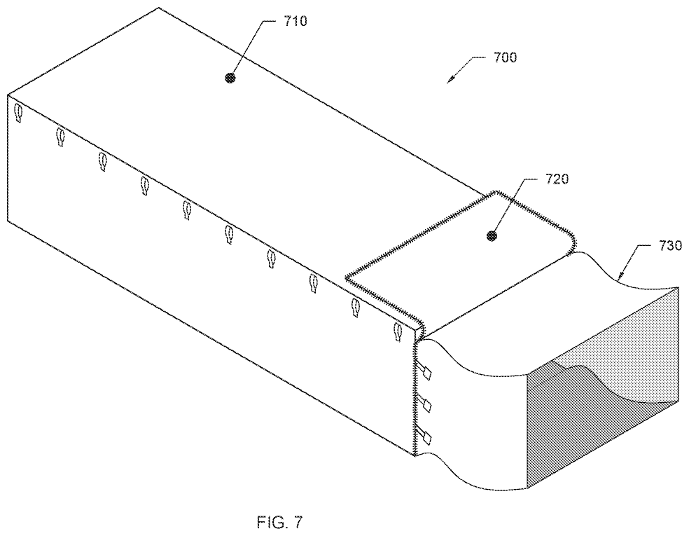

FIG. 7 is a perspective view of a one embodiment of a new and improved industrial containment bag 700, wherein the bag comprises: (a) an exterior layer 710 with an upwardly-opening end flap 720, and (b) an integrated non-perforated liner 730, wherein the integration of the liner is accomplished by a direct attachment means (e.g., by a sewing process).

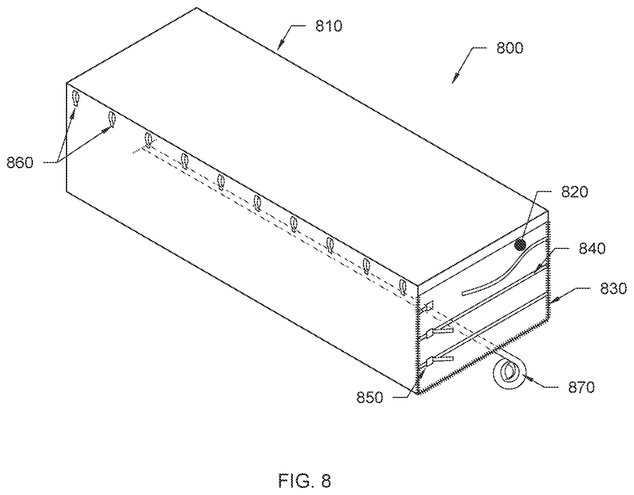

FIG. 8 is a perspective view of a one embodiment of a new and improved industrial containment bag 800, wherein the bag comprises: (a) an exterior layer 810 with a downwardly-opening end flap 820, and (b) an integrated non-perforated liner, wherein the integration of the liner is accomplished by a direct attachment means (e.g., by a sewing process), and wherein the bag is in its fully-closed configuration. In this figure, the closed flap 820 is secured in place not only by its zipper closure system 830; but also, by the tie straps 840 and receiving buckles 850. FIG. 8 also illustrates that bag 800 has a series of hold-up loops 860 and a pull strap 870 that is fixedly attached to the bottom of bag 800.

In this specification, unless otherwise stated, industrial containment bags identified herein as being “non-self-supporting” are to be assumed as employing some sort of a method for holding their sidewalls in an upright position within a supporting structure when the bag is empty—even if a particular hold-up method is not disclosed or illustrated for that particular industrial containment bag. It is also to be assumed that, unless otherwise stated, such methods for holding the sidewalls of non-self-supporting bags in an upright position within a supporting structure when the bag can either be any conventional method known in the industry, or any new method that may be invented in the future.

In addition to the above, regardless of whether the industrial containments encompassed by this invention are self-supporting or non-self-supporting, it may be desirable to lift or move those bags once filled. Regarding prior art containment bags where subsequent lifting/moving is desired, there are many ways in which this can be accomplished. Examples of conventional containment bag lifting/moving techniques include, without limitation, the use of the following: (a) a fork lift or pallet system designed to lift the bag from its top or bottom; (b) “pull straps” designed to pull/slide the bag; (c) a lifting strap system where the straps are everywhere detached from the bag (see, e.g., U.S. Pat. No. 8,894,281 (the '281 patent), U.S. Pat. No. 8,894,282 (the '282 patent), U.S. Pat. No. 9,365,345 (the '345 patent) and U.S. Pat. No. 9,493,299 (the '299 patent)—all of which are herein incorporated in their entirety by reference); (d) a lifting strap system where the straps are attached (e.g., sewn) to the bag's bottom and sidewalls (see, e.g., U.S. Pat. No. 6,155,772 (the '772 patent) and U.S. Pat. No. 6,079,934 (the '934 patent)—all of which are herein incorporated in their entirety by reference); and (e) a lifting strap system where the straps are attached to the bag's bottom, but not to the bag' sidewalls (see, e.g., “Soft-Sided Waste Containers” published by the U.S. Department of Energy in July 1999—the “Innovative Technology 1999 Report”),If/When it becomes desirable to lift/move industrial containment bags encompassed by the present invention, unless otherwise stated, such bags are assumed employ some sort of a method for doing the same (—even if a particular lifting/moving method is not disclosed or illustrated for that particular industrial containment bag. It is also to be assumed that, unless otherwise stated, such methods for lifting/moving such bags can either be any conventional method known in the industry, or any new method that may be invented in the future.

The outer layer of the containment bags encompassed by this invention can be made of woven and/or non-woven materials. Examples of materials that can be used to make the bag's outer layer include, without limitation, the following: a woven polypropylene, a polyvinyl chloride (PVC)—reinforced or non-reinforced, a woven or non-woven polyethylene, or other suitable materials, such as woven fiberglass. Furthermore, the material from which containment bag's outer layer is made can also be coated. Examples of materials that can be used to coat the material making up the bag's outer layer include, without limitation, the following: a polyethylene or polypropylene coating placed on the interior or exterior of the bag.

In one preferred embodiment, the bag's outer layer has a top portion, sidewall portions, and a bottom portion. The outer layer's top portion is parallel to, and laterally spaced above, the outer layer's bottom portion; the outer layer's bottom portion is parallel to, and laterally spaced below, the outer layer's top portion; and the outer layer's sidewall portions are perpendicular to the outer layer's top and bottom portions and positioned therebetween.

The path along which the outer layer's sidewall portions meet with the outer layer's top portion creates the outer layer's top perimeter edge. Similarly, the path along which the outer layer's sidewall portions meet with the outer layer's bottom portion creates the outer layer's bottom perimeter edge.

The bag's integrated non-perforated liner can be made of any suitable material known to those skilled in the art. One example of a material from which a suitable liner can be made is a low-density polyethylene. One particular illustrative example of a suitable inner liner that can be employed with the new and improved industrial containment bags encompassed by this invention is disclosed in U.S. Pat. No. 5,110,005 (the '005 patent)—herein incorporated in its entirety by reference.

In one preferred embodiment, the non-perforated liner has a top portion, sidewall portions, and a bottom portion. The non-perforated liner's top portion is parallel to, and laterally spaced above, the non-perforated liner's bottom portion; the non-perforated liner's bottom portion is parallel to, and laterally spaced below, the non-perforated liner's top portion; and the non-perforated liner's sidewall portions are perpendicular to the non-perforated liner's top and bottom portions and positioned therebetween.

The path along which the non-perforated liner's sidewall portions meet with the non-perforated liner's top portion creates the non-perforated liner's top perimeter edge. Similarly, the path along which the non-perforated liner's sidewall portions meet with the non-perforated liner's bottom portion creates the non-perforated liner's bottom perimeter edge.

In another preferred embodiment, the non-perforated liner's top and bottom perimeter edges are substantially aligned with the outer layer's top and bottom perimeter edges—one example of which is illustrated in FIG. 5.

The containment bags of the present invention can have multiple outer layers. If multiple outer layers are employed, these layers can be made of a woven or a non-woven material, or one can be made of a woven material while the other is made of a non-woven material. In addition, a liquid impervious outer layer can, optionally, be sandwiched between the bag's inner and outer layers, or the bag's inner and/or outer layer, itself, can be made of a liquid impervious material.

In practice, such multiple-layered bags can be manufactured separately; and thereafter, one bag inserted into the other (i.e., a “nested relationship”) until the desired number of layers making up the multiple-layered final product is achieved. The individual bags making up such a multiple-layered final product are then fixedly joined together (e.g., by stitching).

In one illustrative example, the innermost layer can be a bag which is made from a felt-like material that is puncture resistant. In such a situation, this felt-like material can further operate as a thin cushion; thus, helping to maintain bag integrity when materials are dumped therein. The bag's outer layer can be a bag which is made from a strong tear resistant material which helps keep the multi-layered bag system together during filling, lifting storing and/or disposing processes. This particular combination of such a two-layer containment system provides a resilient and strong industrial containment bag system.

The industrial containment bags encompassed by this invention can be “self-supporting”

As used herein, the term “self-supporting” refers to industrial containment bags which can stand upright on their own when empty. As such, self-supporting industrial containment bags need not be used in conjunction with dumpster-type containers or rigid loading frames. They can, however, be used with such dumpster-type containers or rigid loading frames, if desired.

While self-supporting industrial containment bags are made of soft-sided materials, they have integrated therewith means for providing rigid support to at least the bag's side walls. The incorporation of such a rigid support means facilitates the self-supporting industrial containment bags' ability to be positioned in a self-standing position when empty, and to remain in a self-standing position during the filling process.

The rigid supporting means used in a self-supporting industrial containment bag encompassed by this invention can be integrated onto the bag's sidewalls. In this embodiment, the rigid supporting means are attached to the sidewalls' outside and/or inside surface. The attachment can be by any suitable means known in the art. Examples of such suitable attachment means include, without limitation, the following: gluing, stapling, sewing, taping, using a hook and loop attachment system, etc.

The rigid supporting means used in a self-supporting industrial containment bag encompassed by this invention can also be integrated into the bag's sidewalls. In this embodiment, the rigid supporting means are sandwiched between two separate layers of the bag's sidewalls. In addition to being sandwiched between two of the bag's layers, the rigid support means can also be attached to the sidewalls by any suitable means known in the art, such as, for example: gluing, stapling, sewing, taping, using a hook and loop attachment system, etc. It is also within the scope of this invention to have improved self-supporting industrial containment bag designs which employ rigid supporting means which are integrated both, into and onto, the bag's sidewalls.

Examples of rigid supporting means that can be used when practicing this invention include, without limitation, the following: cardboard, rigid plastic, metal, etc. The preferred material (and thickness) is dependent, at least in part, upon factors such as: the desired end use, whether the nature of the material or waste being contained in the bag, and/or regulations imposed by a federal, state or local governments or agencies regarding the filling, transporting, storing and/or disposing of materials or wastes being contained. For example, if a self-supporting industrial containment bag encompassed by this invention is used in instances where liquids and/or gases are needed to permeate through the bag's walls, the rigid supporting means can be designed in a manner, or selected from a group of materials, which do not prevent such a desired permeation from occurring. On the other hand, if a self-supporting industrial containment bag encompassed by this invention is used in instances where liquids and/or gases are not to permeate through the bag's walls, the rigid supporting means can be designed in a manner, selected from a group of materials and/or coated with a material, which prevent such a permeation from occurring.

The industrial containment bags of the present invention can also be “non-self-supporting”.

As used herein, the term “non-self-supporting” refers to industrial containment bags which cannot stand upright on their own when empty. As such, non-self-supporting industrial containment bags need to be used in conjunction with some structure that can support them in an upright position when they are in an empty state and being filled. Examples of structures with which non-self-supporting industrial containment bags can be used in conjunction to support the bags in an upright position when empty includes, without limitation, commercial dumpster-type containers and loading frames.

Examples of commercial dumpster-type containers that can be used in conjunction with industrial containment bags encompassed by the present invention include, without limitation, roll-off containers, end-dump containers, and rail car gondola containers. A detailed description of illustrative examples of such dumpster-type containers is set out in the '212 patent, which, as stated above, is incorporated herein, in its entirety, by reference.

On the other hand, the loading frames differ from commercial dumpster-type containers in that, such loading frames are not designed to hold industrial bulk materials and wastes without the use on containment bags. An illustrative example of a loading frame that can be used when practicing this invention has a continuous horizontal top frame spaced from the ground. This top frame defines a loading perimeter. This illustrative example of a loading frame also has sidewalls and a bottom. Often times, the sidewalls and bottom are not solid closures since the fame is not designed to contain a bulk material or waste. Rather, rigid lading frames are designed to hold non-self-supporting industrial containment bags in an upright position so that the bags can be filled with bulk materials or wastes.

When an industrial containment bag encompassed by this invention is used in conjunction with a loading frame, the bag sidewall, when positioned in the loading frame, is adjacent to the frame sidewall and the bag bottom portion is adjacent the loading frame bottom and the single closable top, when opened, is substantially aligned with the upper terminating edge of the frame sidewall. the bag is then secured to the frame in a manner which holds the empty bag open and in an upright position. The bag is then filled with the bulk material or waste. Then, once filled, the containment bag is removed from the rigid loading frame. In certain instances, the walls of the loading frame are designed to open or expand so as to facilitate the removal of the filled bag therefrom.

Any closure system can be used to open and close the at least one closable opening of the industrial containment bags encompassed by the present invention, as well as to open and close an inspection flap(s), if that embodiment is being practiced either independently or along with other embodiments of this invention. Examples of closure systems that can be employed when practicing the various embodiments of this invention include, without limitation, the following: hook and loop closure systems (e.g., Velcro®-type closure systems, etc.), conventional zipper closure systems (e.g., a coil nylon or metal zipper with at least one pull positioned on the zipper tracks), toothless zipper closure systems (e.g., Ziploc®-type closure systems, MaxiGrie-type closure systems, U-MaxiGrie-type closure systems, etc.) and/or closure systems specifically disclosed in any of the following U.S. patents and patent applications: the '772 patent, the '676 patent, the '511 patent, the '722 patent, the '212 patent, the '953 patent, the '281 patent, the '282 patent, the '175 patent, the '322 patent, the '174 patent, the '935 application, and the '662 application—all of which have been incorporated, in their entirety, herein by reference.

The preferred closure system configuration employed on industrial containment bags encompassed by the present invention depends, at least in part, upon factors such as: the desired end use, whether the seal needs to be air-tight and/or water-tight, the nature of the material or waste being contained therein, and/or regulations imposed by a federal, state or local governments or agencies regarding the filling, transporting, storing and/or disposing of materials or wastes being contained.

Regardless of whether the industrial containment bags encompassed by this invention are self-supporting or non-self-supporting, due to their industrial use they typically contain a significant amount of materials or wastes weighing a tremendous amount. Generally, the location where such bags are being filled is generally not their final destination. As such, in most (but not all) instances, after being filled, the bags need to be lifted or slid into and/or out of some sort of a container or means of transportation. As such, the industrial bags encompassed by this invention can incorporate a means for lifting or sliding the same.

Lifting and/or sliding means that can be incorporated as a part of the industrial bags encompassed by this invention include, without limitation, the following: (a) pick-up or attachment loops or handles that are attached to the bags' outer surface in a direct manner (e.g., by sewing); (b) lifting or sliding strap systems that are at least partially attached to a portion of the bags' outer surface in a direct manner (e.g., by sewing)—i.e., where the lifting or sliding strap systems are attached to the bag's sidewalls and bottom, where the lifting or sliding strap systems are attached only to the bag's sidewalls, or where the lifting or sliding strap systems are attached only to the bag's bottom,; (c) lifting sling systems that are only indirectly attached to the bags' outer surface (e.g., by coupling)—i.e., where the lifting or sliding strap systems are everywhere detached from the bags; and/or (d) lifting pallet systems incorporated as a part of the bags' outer surface.

Illustrative examples of lifting methods, lifting systems and lifting apparatuses can be used to lift such containment bags encompassed by this invention include, without limitation, those disclosed in the following patents and patent applications: the '934 patent, the '727 patent, the '772 patent, the '281 patent, the '282 patent, the '299 patent, the '345 patent, and the '662 application—all of which have already been incorporated herein in their entirety by reference. In addition, the bags can be lifted out of the container by the use of a pallet system and a pallet lifting device. Moreover, the bags can also be slid or dumped out of a dumpster-type container or a rigid loading frame.

As mentioned above, if a lifting strap system is employed when practicing certain embodiments of this invention, the individual straps making up the same can be: (a) directly attached (e.g., by sewing) to the bag's outer surface at those locations where the straps contact the same—e.g., the straps are directly attached to both the bag's bottom portion and/or the bag's sidewall portions, (b) directly attached (e.g., by sewing) to only a portion of the bag's outer surface at those locations where the straps contact the same—e.g., the straps are only directly attached to the bag's bottom portion or to the bag's sidewall portions, (c) only indirectly attached to the bag's outer surface—e.g., the straps are not sewn anywhere to the bag's outer surface; rather, they are only coupled thereto by slidingly being passed through some sort of a coupling means (see, e.g., the '281 patent, the '282 patent, the '299 patent, the '345 patent, and/or the '662 application).

Also, if a lifting strap system is employed when practicing certain embodiments of this invention, the individual straps making up the same need not go all the way around the bag's bottom and sidewall portions—e.g., it is possible for the straps to only be directly attached to the bag's sidewalls.

A lifting strap system that can be employed when practicing certain embodiments of this invention can also be one where it is directly attached to a supporting structure which is directly adjacent to the bottom portion of the bag. In such a lifting system configuration, the supporting structure can be (a) substantially smaller than the footprint of the bag's bottom portion, (b) substantially equal to the footprint of the bag's bottom portion, or (c) substantially larger than the footprint of the bag's bottom portion. In the latter configuration, a portion of the supporting structure would transgress at least partially up at least two of the bag's sidewalls, at least partially up at least three of the bag's sidewalls, or at least partially up all of the bag's sidewalls.

If employed, the supporting structure can be a rigid structure (e.g., a pallet) or a flexible structure (e.g., a soft-sided fabric material). In any instance where a supporting structure is employed, it needs to be constructed in a manner, and of a material, sufficient to support the bag and its contents during lifting and transporting processes and procedures.

If a “rigid” supporting structure is employed, it can be used to lift the bag via a lifting machine (e.g., a forklift) or a lifting crane. In the latter instance where the rigid supporting structure is lifted by a lifting crane, it will preferably have lifting straps attached thereto.

In one illustrative example where lifting straps are used in conjunction with a rigid supporting structure, the straps are connected at one point to the supporting structure and have a means for connecting their other end to a lifting crane. In another illustrative example where lifting straps are used in conjunction with a rigid supporting structure, they are continuous and cup the bottom of the structure. In this embodiment, both ends of the lifting straps have a means for connecting them to a lifting crane.

In any instance where lifting strap systems are used to lift industrial containment bags, especially those encompassed by the present invention, the construction and/or use of such strap systems are regulated by the end user(s), as well as by federal, state and/or local governments and agencies. Accordingly, if employed, the selection of materials used for specific lifting strap systems, as well as the configurations, designs and/or lifting techniques and practices associated with the same, has to be selected such that they are in full compliance with all such regulations.

It is intended that the following claims be interpreted as covering all such alterations and modifications as fall within the true spirit and scope of the invention.

### CONCLUSION

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained. As various changes could be made in the above methods, systems, and mediums without departing from the scope of the invention, it is intended that all matter contained in the above description and shown in the accompanying drawing(s) shall be interpreted as an illustrative, and not in a limiting, sense.

Having described the invention in detail, it will be apparent that modifications and variations are possible without departing from the scope of the invention defined in the appended claims that follow.

What is claimed:

1. An industrial containment bag comprising at least one outer layer and an integrated non-perforated liner, wherein said non-perforated liner is fixedly attached to said outer layer.

2. The industrial containment bag recited in claim 1, wherein said industrial containment bag is non-self-supporting.

3. The industrial containment bag recited in claim 1, wherein said integrated non-perforated liner is fixedly attached to said outer layer by a sewing process.

4. The industrial containment bag recited in claim 1, wherein said outer layer and said integrated non-perforated liner each have at least one opening, and wherein said outer layer's opening substantially aligns with said non-perforated liner's opening.

5. The industrial containment bag recited in claim 4, wherein said outer layer's opening is closable.

6. The industrial containment bag recited in claim 5, wherein said integrated non-perforated liner's opening is closable.

7. The industrial containment bag recited in claim 6, wherein said outer layer has a top portion, a sidewall portion, and a bottom portion, wherein said outer layer's top portion is parallel to, and laterally spaced above, said outer layer's bottom portion, wherein said outer layer's sidewall portion is perpendicular to, and positioned between, said outer layer's top and bottom portions, and wherein said outer layer's outer closable opening is located on said outer layer's top portion.

8. The industrial containment bag recited in claim 6, wherein said outer layer has a top portion, a sidewall portion, and a bottom portion, wherein said outer layer's top portion is parallel to, and laterally spaced above, said outer layer's bottom portion, wherein said outer layer's sidewall portion is perpendicular to, and positioned between, said outer layer's top and bottom portions, and wherein said outer layer's outer closable opening is located on said outer layer's sidewall portion.

9. An industrial containment bag comprising at least one outer layer and an integrated non-perforated liner,
wherein said non-perforated liner is fixedly attached to said outer layer;
wherein said outer layer has an opening, a top portion, a sidewall portion, and a bottom portion, wherein said outer layer's top portion is parallel to, and laterally spaced above, said outer layer's bottom portion, and wherein said outer layer's sidewall portion is perpendicular to, and positioned between, said outer layer's top and bottom portions;
wherein the path along which said outer layer's sidewall portion meets with said outer layer's top portion creates a top perimeter edge of said outer layer, and wherein the path along which said outer layer's sidewall portion meets with said outer layer's bottom portion creates a bottom perimeter edge of said outer layer;
wherein said non-perforated liner has an opening, a top portion, a sidewall portion, and a bottom portion, wherein said non-perforated liner's top portion is parallel to, and laterally spaced above, said non-perforated liner's bottom portion, and wherein said non-perforated liner's sidewall portion is perpendicular to, and positioned between, said non-perforated liner's top and bottom portions;
wherein the path along which said non-perforated liner's sidewall portion meets with said non-perforated liner's top portion creates a top perimeter edge of said non-perforated liner, and wherein the path along which said non-perforated liner's sidewall portion meets with said non-perforated liner's bottom portion creates a bottom perimeter edge of said non-perforated liner;
wherein said non-perforated liner's top and bottom perimeter edges are substantially aligned with said outer layer's top and bottom perimeter edges, respectively; and
wherein said outer layer's opening substantially aligns with said non-perforated liner's opening.

10. The industrial containment bag recited in claim 9, wherein said outer layer's opening is closable.

11. The industrial containment bag recited in claim 9,
wherein said outer layer's top perimeter edge comprises two parallel longitudinal upper perimeter edge sections, and two parallel lateral upper perimeter edge sections which are perpendicular to said outer layer's upper longitudinal perimeter edge sections,
wherein said outer layer's bottom perimeter edge comprises two parallel longitudinal lower perimeter edge sections, and two parallel lateral lower perimeter edge sections which are perpendicular to said outer layer's lower longitudinal perimeter edge sections,
wherein said non-perforated liner's top perimeter edge comprises two parallel longitudinal upper perimeter edge sections, and two parallel lateral upper perimeter edge sections which are perpendicular to said non-perforated liner's upper longitudinal perimeter edge sections, and
wherein said non-perforated liner's bottom perimeter edge comprises two parallel longitudinal lower perimeter edge sections, and two parallel lateral lower perimeter edge sections which are perpendicular to said non-perforated liner's lower longitudinal perimeter edge sections.

12. The industrial containment bag recited in claim 11, wherein said non-perforated liner comprises a series of integration tabs, wherein each of said series of integration tabs has a first end that is fixedly secured to a portion of said non-perforated liner's top perimeter edge by a non-perforation securing means, and a second end that freely extends beyond said integrated tab's secured first end.

13. The industrial containment bag recited in claim 12, wherein said non-perforation securing means comprises at least one of the following: tape or glue.

14. The industrial containment bag recited in claim 12, wherein said series of integration tabs comprises an upper series of integration tabs.

15. The industrial containment bag recited in claim 14, wherein said second end of each of said upper series of integration tabs is sandwiched between a portion of said outer layer's top portion and a portion of said outer layer's sidewall portion, and sewn into a portion of said outer layer's top perimeter edge.

16. The industrial containment bag recited in claim 15, wherein a first of said upper series of integration tabs which integrated into a portion of said outer layer's top perimeter edge is sewn onto one of the two said longitudinal upper perimeter edge sections; and wherein a second of said upper series of integration tabs which integrated into a portion of said outer layer's top perimeter edge is sewn onto the other of the two said longitudinal upper perimeter edge sections.

17. The industrial containment bag recited in claim 14, wherein said series of integration tabs comprises a lower series of integration tabs.

18. The industrial containment bag recited in claim 17, wherein said second end of each of said lower series of integration tabs is sandwiched between a portion of said outer layer's bottom portion and a portion of said outer layer's sidewall portion, and sewn into a portion of said outer layer's bottom perimeter edge.

19. The industrial containment bag recited in claim 9, wherein said industrial containment bag is self-supporting.

20. The industrial containment bag recited in claim 9, wherein said non-perforated liner is fixedly attached to said outer layer by a sewing process.
